(19) United States
(12) Patent Application Publication
(10) Pub. No.: US 2025/0249820 A1
(43) Pub. Date: Aug. 7, 2025

(54) COUPLING DEVICE FOR AUTONOMOUS MOBILE ROBOTS

(71) Applicant: Eureka System S.r.l, Villorba (IT)

(72) Inventor: Eros CONTO', Paese (IT)

(21) Appl. No.: 18/855,660

(22) PCT Filed: Apr. 6, 2023
(86) PCT No.: PCT/EP2023/059273

§ 371 Date: Oct. 10, 2024

(30) Foreign Application Priority Data
Apr. 13, 2022 (IT) 102022000007331

(51) Int. Cl. B60P 7/06; B60P 3/06

(52) U.S. Cl. CPC B60P 7/06; B60P 3/06

(57) ABSTRACT

A coupling device for autonomous mobile robots has two arms which are pivoted at a first end to the robot, and which can splay on a horizontal plane using electrically-actuated linear actuators. The two arms are provided at a second end with conical cutouts which are adapted to intercept respective pins. The pins can be removably inserted in seats provided on a bottom of an overlying cart. The cart can move on idle wheels.

The present invention relates to a coupling device for autonomous mobile robots.

Nowadays robots are known, also called “AMRs” or “Autonomous Mobile Robots”, which are used for moving various products and/or semi-finished products in industrial environments.

Conventional AMRs are provided with wheels driven by navigation systems which, using preset maps and dedicated software, enable for example the end-of-line movement of various products.

They have excellent positioning capacity and great precision and rapidity of movements, all of which enable them to move around safely and quickly in production environments.

AMRs are also known that are capable of towing a load or a cart which is automatically hitched to them, creating an articulated system; such solution has drawbacks however, in that the combination of the AMR and the cart extends lengthwise which limits the capacity for changing direction in the event it needs to follow a nonlinear path.

AMRs are also known that are positioned below a cart and are coupled to the cart using, for the connection, actuators in the form of self-centering conical pins that progressively protrude upward and enter adapted holes in the bottom of the cart.

This solution also presents drawbacks: there is in fact the risk that the pins (of which there are a minimum of two if an optimal AMR/cart engagement is to be obtained) do not enter the holes correctly, this risk deriving from the high degree of precision of positioning required on the part of the AMR in order to align the pins with the holes of the cart; accuracy and repeatability of positioning for an AMR robot defined as “precise” is of the order of +/−10 mm.

There is also the possibility that the AMR and the cart can be arranged on different planes owing to slight unevenness in the floor; this can cause the pin to stick, with consequent lifting and probable overturning of the cart.

Furthermore, on floors with slight unevenness, the AMR and the cart will move on planes with different inclinations, thus making it necessary to have a minimum degree of freedom between them, while the conical pin greatly limits such freedom.

Finally, in the event of an anomaly with the AMR, the cart must be brought to its destination manually, thus making it necessary to disengage them with a manual maneuver; the pin, which is actuated electrically, must therefore have a mechanism that allows it to be lowered manually, which increases manufacturing costs and running costs.

The aim of the present invention is to solve the above mentioned technical problems, eliminating the drawbacks in the cited known art, by providing a coupling device for autonomous mobile robots that, applied to an AMR, enables a rapid, effective, precise and fast mating to/separation from a cart that is adapted to support suitable devices to be moved.

Within the above aim, an object of the invention is to provide a coupling device for autonomous mobile robots that, applied to an AMR, makes it possible to effectively move a cart even in the presence of nonlinear paths.

Another object of the invention is to provide a coupling device for autonomous mobile robots that is structurally simple and of low cost and which can be made with the usual conventional plants.

This aim and these and other objects which will become better apparent hereinafter are achieved by a coupling device for autonomous mobile robots, characterized in that it has two arms, which are configured to be pivoted at a first end to said robot and can splay on a horizontal plane using electrically-actuated linear actuators, said two arms being provided at a second end with conical cutouts which are adapted to intercept respective pins which can be removably inserted in seats provided on the bottom of an overlying cart which is configured to move on idle wheels 27.

Further characteristics and advantages of the invention will become better apparent from the detailed description of a particular but not exclusive embodiment thereof, illustrated by way of non-limiting example in the accompanying drawings, wherein:

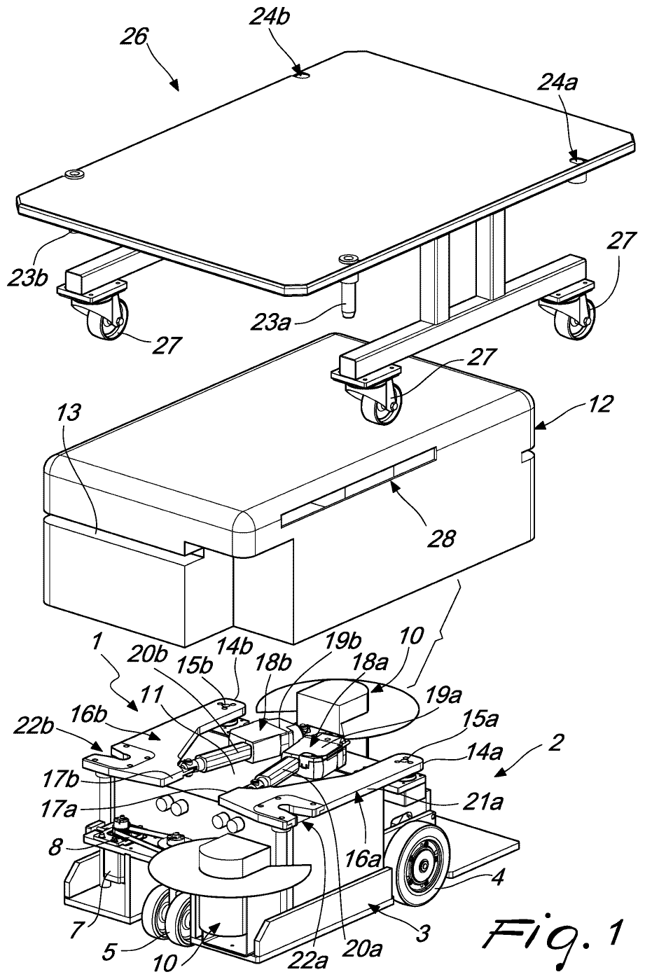

FIG. 1 is an exploded view of the coupling device according to the present invention;

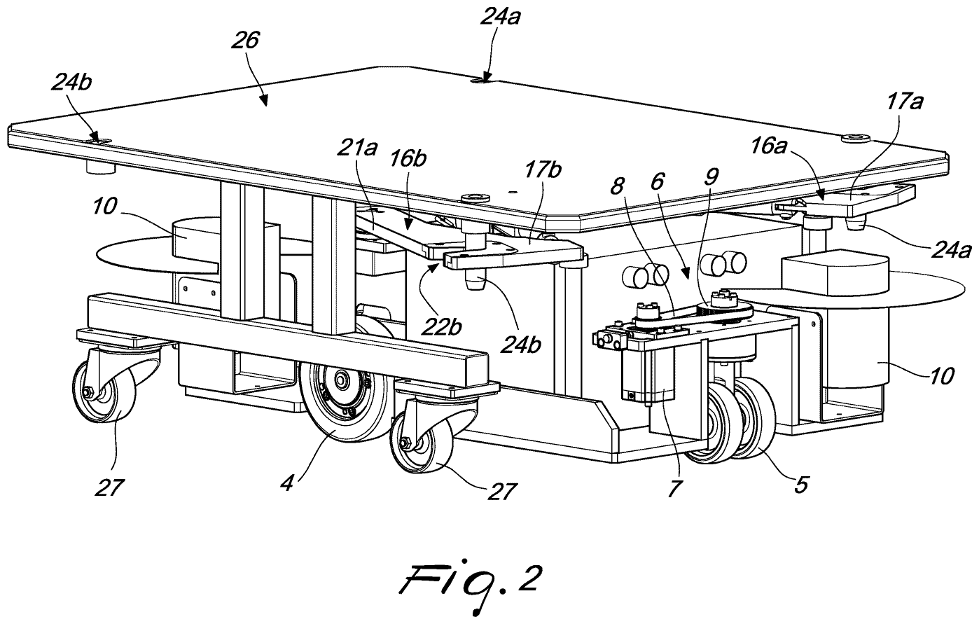

FIG. 2 is a perspective view of the coupling device in the condition of engagement with the cart;

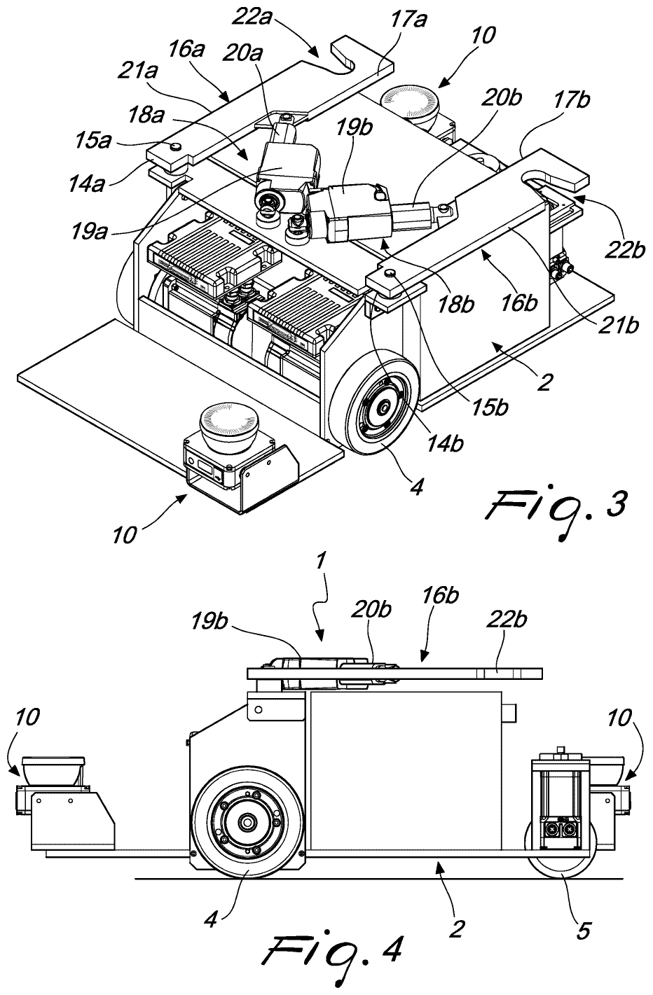

FIG. 3 is a perspective view of the coupling device without the cover;

FIG. 4 is a side view of the coupling device without the cover;

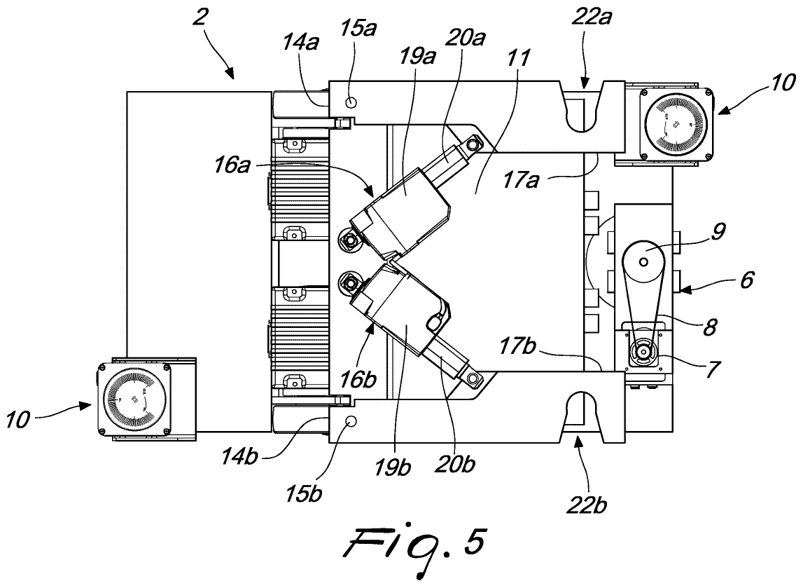

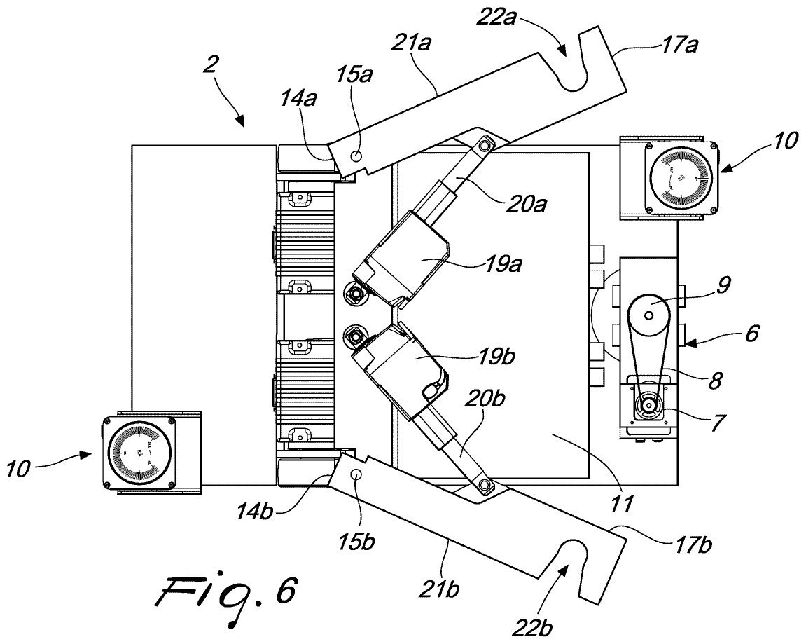

FIG. 5 is a view from above of the coupling device without the cover in the condition of disengagement from the cart;

FIG. 6 is a view from above of the coupling device without the cover in the condition of engagement with the cart.

In the embodiments that follow, individual characteristics, given in relation to specific embodiments, may actually be interchanged with other, different characteristics that exist in other embodiments.

With reference to the figures, the reference numeral 1 generally designates a coupling device for autonomous mobile robots 2 of the type that comprises a frame 3 for supporting drive wheels 4 and swiveling wheels 5 which are coupled to adapted activation means 6, such as a motor 7 connected by a belt 8 to a pinion 9 adapted to drive the rotation of said swiveling wheels 5.

The frame 2 is further associated, in the front and rear zones, with sensors 10 which are adapted to generate a proximity scan for guiding the robot.

The frame 2 has a substantially parallelepiped shape structure, so as to define a substantially planar upper surface 11, and a protective cover 12 can be superimposed thereon, adapted slots 13 being provided on said cover for the sensors 10.

At the longitudinal sides of the upper surface 11, two arms 16a, 16b are pivoted to a first end 14a, 14b by means of adapted pivots 15a, 15b, and are thus arranged on a horizontal plane and have a length substantially equal to that of the upper surface 11 and a width such as to allow them to splay starting from an inactive condition in which they rest, lengthwise, in the perimeter defined by the upper surface 11.

Each arm 16a, 16b is, in plan view, substantially L-shaped in structure so as to define a second end 17a, 17b, said second ends being arranged mutually opposite and oriented toward the longitudinal perimetric edge of the upper surface 11.

Adapted openings 28 are provided on the cover 12 and are adapted to allow the exit, through them, of the second ends 17a, 17b in the splayed condition for the arms 16a, 16b.

The splaying of the arms 16a, 16b is allowed by the electrically-controlled linear actuators 18a, 18b, the body 19a, 19b of which is pivoted to the upper surface 11 and the stem 20a, 20b of which is pivoted at the second ends 17a, 17b.

At the perimetric edge 21a, 21b of the arms 16a, 16b opposite to the second end 17a, 17b, there are conical cutouts 22a, 22b which are adapted to intercept respective pins 23a, 23b which can be removably inserted in adapted seats 24a, 24b provided on the bottom 25 of an overlying cart 26 which can move on idle wheels 27.

Thus it has been found that the invention fully achieves the intended aim and objects, a coupling device having been obtained that, applied to an AMR, enables a rapid, effective, precise and fast mating to/separation from a cart that is adapted to support suitable devices to be moved.

In fact the two arms 16a, 16b pivoted to the upper surface 11 are splayed by the electrically-controlled linear actuators 18a, 18b while the conical cutouts 22a, 22b intercept respectively the two pins 23a, 23b on the bottom 25 of the cart 26, in so doing automatically centering it; opening the two arms 16a, 16b continues up until complete engagement.

The coupling device 1 allows the pins 23a, 23b to slide vertically and therefore offers the cart 26 a degree of freedom on the vertical axis.

The pins 23a, 23b are nail-shaped and are inserted into the seats 24a, 24b present in the cart 26 and are directed with the stem downward; their removal occurs simply by extracting the pin 26 upward, in so doing rapidly decoupling the AMR from the cart.

Advantageously the conical cutouts 22a, 22b and the pins 23a, 23b will be coated in self-lubricating plastic material in order to decrease friction.

The coupling device applied to an AMR furthermore makes it possible to effectively move a cart even in the presence of nonlinear paths.

The coupling device 1 can be of the type that can be overturned with respect to the plane of arrangement of the upper surface 11 the two arms 16a, 16b being associated with a plate which in turn is associated, in a manner that allows its overturning, with the upper surface 11 in order to allow the entry of a battery into an adapted and underlying compartment.

Naturally the materials used as well as the dimensions of the individual components of the device according to the invention may be more relevant according to specific requirements.

The characteristics indicated above as advantageous, convenient or the like, may also be missing or be substituted by equivalent characteristics.

The disclosures in Italian Patent Application No. 102022000007331 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-9. (canceled)

10. A coupling device for autonomous mobile robots, comprising two arms, which are configured to be pivoted at a first end to a robot and can splay on a horizontal plane using electrically-actuated linear actuators, said two arms being provided at a second end with conical cutouts which are adapted to intercept respective pins which are configured to be removably inserted in seats provided on a bottom of an overlying cart which is configured to move on idle wheels.

11. The device according to claim 10, further comprising a frame which has a substantially parallelepiped shape structure so as to define a substantially planar upper surface, a protective cover being configured to be superimposed thereon, slots being provided thereon for sensors adapted to generate a proximity scan.

12. The device according to claim 11, wherein said two arms are pivoted, at longitudinal sides of said substantially planar upper surface, to said first end by means of pivots, and are thus arranged on a horizontal plane and have a length substantially equal to a length of said upper surface and a width such as to allow said two arms to splay starting from an inactive condition in which the two arms rest, lengthwise, in a perimeter defined by said substantially planar upper surface.

13. The device according to claim 11, wherein each one of said arms is, in plan view, substantially L-shaped in structure, so as to define said second ends, which are arranged mutually opposite and oriented toward a longitudinal perimetric edge of said substantially planar upper surface.

14. The device according to claim 12, wherein said protective cover is configured to be associated with said autonomous mobile robot and openings are provided thereon which are adapted to allow an exit, through said openings, of said second ends in the splayed condition for said arms.

15. The device according to claim 12, wherein splaying of said arms is allowed by said electrically-controlled linear actuators, a body of which is pivoted to said substantially planar upper surface and a stem of which is pivoted at said second ends.

16. The device according to claim 10, wherein said conical cutouts are provided at a perimetric edge of said two arms that is opposite to said second ends, and are adapted to intercept said pins which are configured to be removably inserted into seats provided on the bottom of said overlying cart.

17. The device according to claim 10, wherein said pins are nail-shaped and are directed with stems thereof downward; removal of said pins occurring by extracting the pins said seats provided on said bottom

18. The device according to claim 11, configured to be overturned with respect to a plane of arrangement of said substantially planar upper surface, said two arms being associated with a plate which in turn is associated, in a manner that allows overturning of said plate, with said substantially planar upper surface in order to allow entry of a battery into an underlying compartment.
